(19) United States
(12) Patent Application Publication
(10) Pub. No.: US 2001/0040854 A1
(43) Pub. Date: Nov. 15, 2001

(54) OPTICAL RECORDING/PICKUP HEAD COMPATIBLE WITH COMPACT DISK-RECORDABLE (CD-R) AND DIGITAL VERSATILE DISK (DVD) USING POLARIZATION BEAM SPLITTER

(76) Inventors: CHUL-WOO LEE, SEOUL (KR); JANG-HOON YOO, SEOUL (KR); CHONG-SAM CHUNG, SUNGNAM-CITY (KR)

Correspondence Address: STAAS & HALSEY LLP, 700 11TH STREET, NW, SUITE 500, WASHINGTON, DC, 20001, US

(21) Appl. No.: 09/031,541

(22) Filed: Feb. 27, 1998

(30) Foreign Application Priority Data
Feb. 27, 1997 (KR) 97-6277

(51) Int. Cl. G11B 7/135

(52) U.S. Cl. 369/112.17

(57) ABSTRACT

An optical recording/pickup head compatible with a CD-R and a DVD transfers a first light beam of 650 nm wavelength for a DVD and a second light beam having a wavelength of 780 nm for a CD-R, which are respectively emitted from a first light source and a second light source, to an objective lens using first and second beam splitters having polarized light beam splitting characteristics which are varied according to a wavelength. The objective lens focuses the transferred first and second light beams on the information recording surfaces of the DVD and a CD-R, respectively. The first and second light beams reflected from the information recording surfaces of the DVD and the CD-R, respectively, are transferred to first and second photodetectors by the first and second beam splitters, respectively. The first and second photodetectors detect information from the first and second light beams incident from the first and second beam splitters, respectively.

### BACKGROUND OF THE INVENTION

1. Field of the Invention

The present invention relates to an optical recording and/or pickup head compatible with optical disks using respective light beams of different wavelengths for recording and reproduction of information, and more particularly, to an optical recording/pickup head compatible with a compact disk-recordable (CD-R) and a digital versatile disk (DVD).

2. Description of the Related Art

In an optical disk apparatus using a recording medium for storing a large quantity of information, a compact disk (CD) and a digital versatile disk (DVD) have been widely used. Recently, a recordable compact disk (CD-R) and a digital versatile disk-random access memory (DVD-RAM) have been known. As well known, when recording and reproduction of information, laser light having a wavelength of 780 nm is used for a CD-R, and laser light having a wavelength of 650 nm or 635 nm is used for a DVD-RAM. Thus, an optical recording/pickup head compatible with a CD-R and a DVD includes two light sources which emit laser light of respectively different wavelengths.

FIG. 1 shows a conventional optical recording/pickup head compatible with a CD-R and a DVD. The optical recording/pickup head includes a first light source 1 for emitting a first light beam having a wavelength of 650 nm for recording and reproduction of information with respect to a DVD 8, a second light source 11 for emitting a second light beam having a wavelength of 780 nm for recording and reproduction of information with respect to a CD-R 9, and an objective lens 7 for respectively focusing the beams of the first and second light emitted by the first and second light sources 1 and 11 on the information recording surfaces of the DVD 8 and the CD-R 9. A collimating lens 2 collimates the first light beam emitted from the first light source 1 into parallel light and transmits the collimated light to a first beam splitter 3. The first beam splitter 3 reflects the first light beam incident from the first collimating lens 2 to an interference filter prism 4. The interference filter prism 4 transmits the first light beam, which is a parallel light beam incident from the first beam splitter 3, to a quarter wavelength plate 5. In more detail, the interference filter prism 4 totally transmits or totally reflects the incident light beam according to a wavelength of the incident light beam, in which a first light beam of a 650 nm wavelength for a DVD is totally transmitted and a second light beam of a 780 nm wavelength incident from a converging (focusing) lens 14 is totally reflected. A thin-film type variable aperture 6 transmits the first light beam, which is the parallel light beam incident from the quarter-wave plate 5, to the objective lens 7. The objective lens 7 focuses the first light beam having passed through the variable aperture 6 on the information recording surface of the DVD 8 having a thickness of 0.6 mm. As a result, the first light beam focused on and reflected from the information recording surface of the DVD 8 by the objective lens 7 contains information recorded on the focused position.

The reflected first light beam from the information recording surface of the DVD 8 passes through the objective lens 7, the variable aperture 6 and the quarter-wave plate 5 in sequence, and then is incident to the interference filter prism 4.

The interference filter prism 4 transmits the first light beam incident from the quarter-wave plate 5 to the first beam splitter 3. The first beam splitter 3 makes the first light beam incident from the interference filter prism 4 proceed to a first photodetector 10. The first photodetector 10 receives the first light beam from the first beam splitter 3 and detects information from the first light beam.

The second light beam of the 780 nm wavelength emitted from the second light source 11 passes through a second collimating lens 12 and a second beam splitter 13, and then incident to the converging lens 14.

The converging lens 14 converges the second light beam incident from the second beam splitter 13 to transmit the second light beam to the interference filter prism 4 in the form of a converged beam.

The interference filter prism 4 transmits the second light beam incident from the converging lens 14 to the quarter-wave plate 5 in a diverging form. The quarter-wave plate 5 transmits the second light beam incident from the interference filter prism 4 to the variable aperture 6.

The variable aperture 6 transmits only part of the second light beam of the 780 nm wavelength being incident in the form of a divergent beam to the objective lens 7. Thus, the second light beam transmitted through the variable aperture 6 is focused on and reflected from the information recording surface of the CD-R 9 having a thickness of 1.2 mm by the objective lens 7. The second light beam reflected from the information recording surface contains information recorded on the focused position.

The reflected first light beam from the information recording surface of the CD-R 9 passes through the objective lens 7, the variable aperture 6, the quarter-wave plate 5 in sequence, and then is incident to the interference filter prism 4.

The interference filter prism 4 transmits the second light beam incident from the quarter-wave plate 5 to the converging lens 14. The converging lens 14 makes the second light beam incident to a second photodetector 15. The second photodetector 15 receives the second light beam from the second beam splitter 13 and detects information from the second light beam.

FIG. 2 shows the thin-film type variable aperture 6 of FIG. 1 in detail. As shown in FIG. 2, the thin-film type variable aperture 6 has a structure which can selectively transmit the light beams incident to the regions whose numerical aperture (NA) is less than or equal to 0.6. Region 1 is a region whose numerical aperture (NA) is less than or equal to 0.45 and which totally transmits the light beam of 780 nm wavelength and 650 nm wavelength. Region 2 is a region whose numerical aperture (NA) is more than 0.45 in which a dielectric thin-film is coated. Here, a multi-layered thin-film having a thickness less than or equal to a wavelength unit is formed in which the light beam having the wavelength of 650 nm is totally transmitted and that having the wavelength of 780 nm is totally reflected. The region 1 is comprised of a quartz (SiO₂) thin film to remove any optical aberration generated by the dielectric thin film coated region 2.

The 780 nm wavelength light passing through the region 1 having the 0.45 NA or below in the variable aperture 6 forms a beam spot appropriate to the CD-R 9 on the information recording surface thereof by the objective lens 7. The 650 nm wavelength light transmitted through the regions 1 and 2 having the 0.6 NA or below in the variable aperture 6 forms a beam spot appropriate to the DVD 8 on the information recording surface thereof by the objective lens 7.

The reason why the second light beam is incident to the objective lens 7 in the diverging form is to focus the second light beam on the information recording surface of the CD-R without having any optical aberration.

Thus, the optical recording/pickup head of FIG. 1 enables recording and reproduction with respect to both a DVD and a CD-R. However, the optical recording/pickup head of FIG. 1 uses several prisms, and particularly uses the interference filter prism 4 and the converging lens 14 to form a finite optical system with respect to the second light beam, which causes an increase of production cost. Since the variable aperture 6 transmits only part of the second light beam incident from the quarter-wave plate 5, a light utilization efficiency is lowered. Also, since the variable aperture 6 should be located at a particular position to obtain an optical spot appropriate for the CD-R 9 from the diverging second light beam, it is difficult to construct the optical system.

### SUMMARY OF THE INVENTION

To solve the above problems, it is an object of the present invention to provide an optical recording/pickup head which provides a simple structure and a high light utilization efficiency of an optical system, by employing a polarizing beam splitter and a beam splitter having a high transmissivity and a high reflectivity to transmit light beams of respectively different wavelengths to an objective lens.

Additional objects and advantages of the invention will be set forth in part in the description which follows and, in part, will be obvious from the description, or may be learned by practice of the invention.

To accomplish the above and other objects of the present invention, there is provided an optical recording/pickup head compatible with at least two types of optical disks in which distances from the optical recording/pickup head to the information recording surfaces differ from each other and information is recorded and reproduced by light beams having a respectively different wavelength, the optical recording/pickup head comprising:

a first light source for emitting a linearly polarized first light beam; a second light source for emitting a linearly polarized second light beam having a longer wavelength than that of the first light beam; a first photodetector; a second photodetector; focusing means for focusing the first and second light beams on information recording surfaces of respectively different optical disks; and optical path alteration means for transmitting the first light beam incident from the first light source and the second light beam incident from the second light source to the focusing means and transmitting the first and second light beams incident from the focusing means to the first and second photodetectors, respectively, wherein the optical path alteration means transfers the first and second light beams so that the light quantities of the first and second light beams incident to the optical path alteration means are substantially the same as quantities of the first and second light beams having passed through the optical path alteration means.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 shows a conventional optical recording/pickup head compatible with a CD-R and a DVD;

FIG. 2 shows the structure of the thin-film type variable aperture used in the optical recording/pickup head of FIG. 1;

FIG. 3 shows an optical recording/pickup head compatible with a DVD and a CD-R according to a first embodiment of the present invention;

FIG. 4 shows an optical recording/pickup head compatible with a DVD and a CD-R according to a second embodiment of the present invention;

FIG. 5 is a graphical view showing optical characteristics of the first beam splitter shown in FIGS. 3 and 4; and

FIG. 6 is a graphical view showing optical characteristics of the second beam splitter shown in FIGS. 3 and 4.

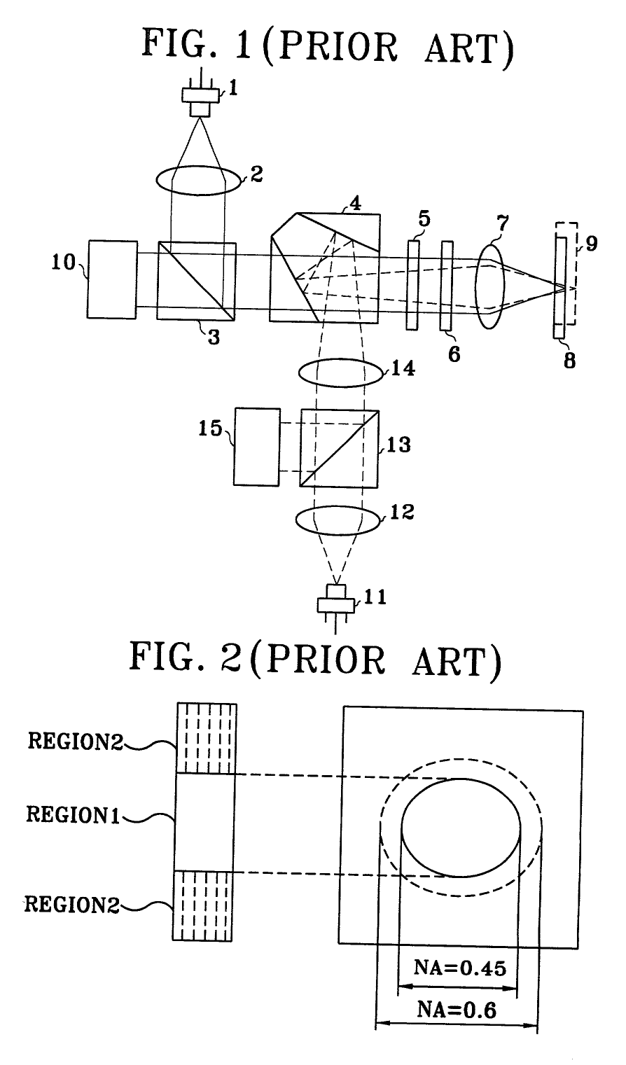

### DETAILED DESCRIPTION OF THE PREFERRED EMBODIMENTS

Preferred embodiments of the present invention will be described in detail with reference to the accompanying drawings.

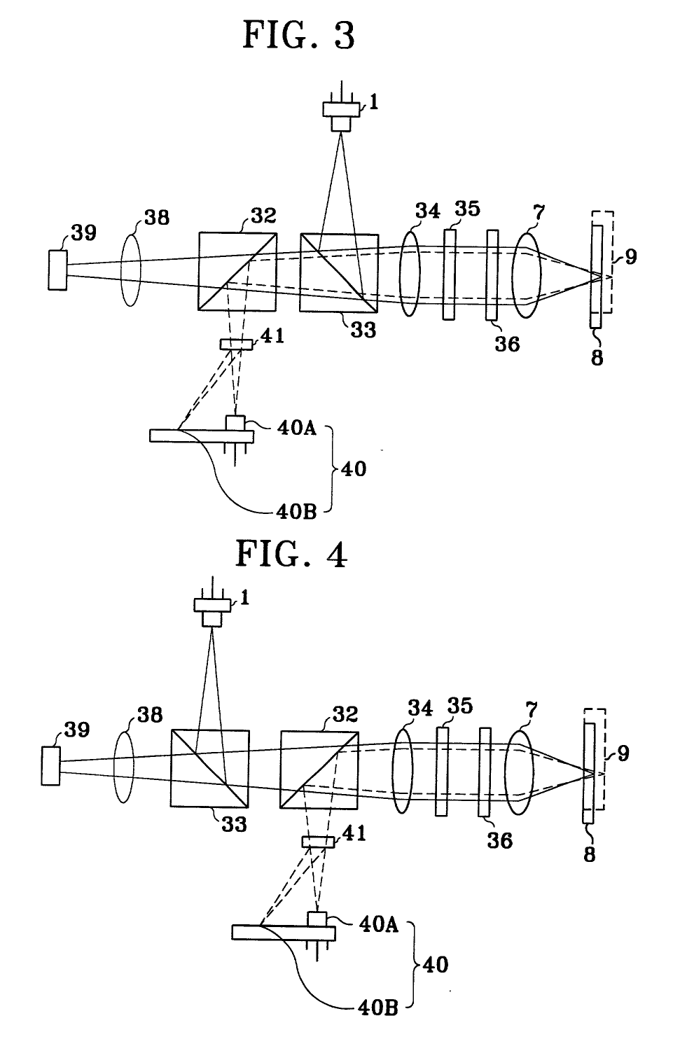

An optical recording/pickup head shown in FIG. 3 includes a first light source 1 for emitting a first light beam having a wavelength of 650 nm, a first photodetector 39 for detecting information from the first light beam reflected from a DVD 8, a light source and photodetector 40 in which a light source 40A for emitting a second light beam having a wavelength of 780 nm and a photodetector 40B for detecting information from the second light beam reflected from a CD-R 9, an objective lens 7 for focusing the first and second light beams on the respective information recording surfaces of the optical disks 8 and 9, and two beam splitters 32 and 33 for reflecting the first light beam emitted from the first light source 1 and the second light beam emitted from the light source and photodetector 40 to the objective lens 7 and transmitting the reflected first light beam and reflecting the second light beams to the photodetectors 39 and 40B, respectively.

The first light source 1 emits the first light beam which is linearly polarized and has a 650 nm wavelength. For convenience of explanation, the first light beam is defined as an S polarization light beam. The first beam splitter 33 which is in close to the objective lens 7 between the two beam splitters 32 and 33 has an optical characteristic that substantially totally reflects an S polarization light beam with respect to the first light beam of the 650 nm wavelength, and substantially totally transmits a P polarization light beam. The first beam splitter 33 substantially totally reflects the first light beam incident from the first light source 1 toward a collimating lens 34. The collimating lens 34 collimates the first light beam incident from the first beam splitter 33 into a parallel light beam and transmits the collimated first light beam to a phase plate 35. The phase plate 35, which is a quarter-wave plate converts the linearly polarized first light beam incident from the collimating lens 34 into a circularly polarized light beam, and transmits the circularly polarized first light beam to a holographic variable aperture 36.

The holographic variable aperture 36 totally transmits the first light beam being incident in the form of a parallel beam from the phase plate 35 to the objective lens 7. The objective lens 7 focuses the first light beam incident from the holographic variable aperture 36 on the information recording surface of the DVD 8 having the thickness of 0.6 mm. As a result, the first light beam contains information recorded on the focused position on the information recording surface of the DVD 8.

The first light beam reflected from the DVD 8 passes through the objective lens 7, the holographic variable aperture 36, and then is reflected toward the phase plate 35. The phase plate 35 converts the circularly polarized first light beam into the linearly polarized light beam. That is, the first light beam becomes a P polarization light beam by the phase plate 35. The linearly polarized first light beam passes through the collimating lens 34, and is incident to the first beam splitter 33. The first beam splitter 33 totally transmits the first light beam, which is a P polarization light beam incident from the collimating lens 34, to the second beam splitter 32. The first beam splitter 33 totally transmits the first light beam, which is a P polarization light beam incident from the collimating lens 34, to the second beam splitter 32. The second beam splitter 32 totally transmits the first light beam of the 650 nm wavelength to a photodetection lens 38. The photodetection lens 38 converges the first light beam on the first photodetector 39. The first photodetector 39 detects information from the first light beam incident from the photodetection lens 38.

The light source 40A included in the light source and photodetector 40 emits a second light beam which is linearly polarized and has a wavelength of 780 nm. For convenience of explanation, the second light beam emitted from the light source and photodetector 40 is an S polarization light beam. The second beam splitter 32 has an optical characteristic that a P polarization light beam and an S polarization light beam are substantially totally reflected with respect to the second light beam of the 780 nm wavelength, and substantially totally reflects the second light beam incident from the light source and photodetector 40 toward the first beam splitter 33. The first beam splitter 33 totally transmits the second light beam of the 780 nm wavelength incident from the second beam splitter 32 to the collimating lens 34.

The collimating lens 34 collimates the second light beam incident from the first beam splitter 33 into a parallel light beam and transmits the result to the phase plate 35. The phase plate 35 converts the linearly polarized second light beam incident from the collimating lens 34 into a circularly polarized light beam and transmits the result to the holographic variable aperture 36. The holographic variable aperture 36 totally transmits the second light beam of 780 nm wavelength incident to a region whose numerical aperture (NA) is less than or equal to 0.36 and transmits about 25% of the second light beam of 780 nm incident to a region whose numerical aperture (NA) is more than or equal to 0.36. The holographic variable aperture 36 transmits a portion of the second light beam incident in parallel from the phase plate 35 and transmits the result to the objective lens 7. The objective lens 7 focuses the second light beam incident from the holographic variable aperture 36 on the information recording surface of the CD-R 9 having the thickness of 1.2 mm. As a result, the second light beam contains information recorded on a focused position on the information recording surface of the CD-R 9.

The second light beam reflected from the CD-R 9 passes through the objective lens 7, the holographic variable aperture 36, and then is incident to the phase plate 35. The phase plate 35 converts the circularly polarized second light beam into the linearly polarized light beam. That is, the second light beam becomes a P polarization light beam by the phase plate 35. The linearly polarized second light beam transmits the collimating lens 34, and is incident to the first beam splitter 33. The first beam splitter 33 totally transmits the second light beam, which is a P polarization light beam incident from the collimating lens 34, to the second beam splitter 32. The second beam splitter 32 substantially totally reflects the second light beam of the 780 nm wavelength, which is a P polarization light beam incident from the first beam splitter 33, toward a holographic beam splitter 41.

The holographic beam splitter 41 diffracts the second light beam incident from the second beam splitter 32 toward the photodetector 40B included in the light source and photodetector 40. The photodetector 40B detects information from the second light beam incident from the holographic beam splitter 41.

FIG. 4 shows an optical recording/pickup head compatible with a DVD and a CD-R according to a second embodiment of the present invention. When the optical recording/pickup head of FIG. 4 is compared with the optical recording/pickup head of FIG. 3, the positions of the first light source 1, the light source and photodetector 40 are reversed. In particular, the first light source 1 is closer to the photodetection lens 38 than the light source and photodetector 40 in a direction parallel to that which the first and second light beams exit the collimating lens 34 toward the phase plate 35. As a result, the positions of the first beam splitter 33 and the second beam splitter 32 are also reversed.

The positions and functions of other components in FIG. 4 are the same as those of FIG. 3 which are denoted by the same reference numerals. Thus, the optical recording/pickup head of FIG. 4 performs an operation of recording and detecting information on and from the DVD 8 and the CD-R 9, respectively, in the same manner as that of FIG. 3.

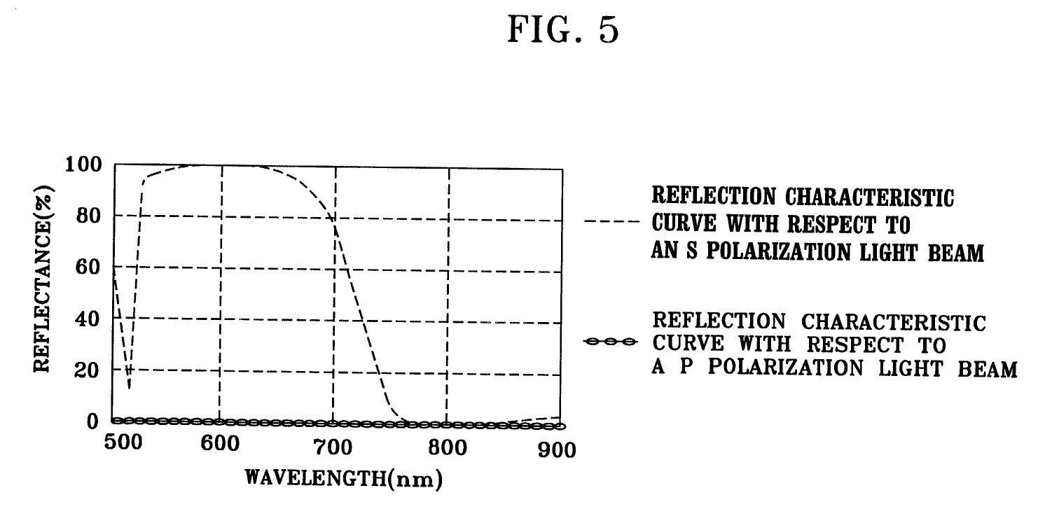

FIG. 5 is a graphical view showing optical characteristics of the first beam splitter 33 used in the optical recording/pickup head shown in FIGS. 3 and 4. In the graphical view of FIG. 5, the horizontal axis represents a wavelength of the light and the vertical axis represents a percentage ratio of a reflected light quantity with respect to an incident light quantity. According to a reflection characteristic curve with respect to an S polarization light beam in the graph, it can be seen that the first beam splitter 33 reflects about 99% of an incident S polarization light beam with respect to a wavelength band ranging from about 550 nm to about 650 nm, and transmits almost 100% of an incident S polarization light beam with respect to a wavelength band ranging from about 760 nm to about 900 nm. According to a reflection characteristic curve with respect to a P polarization light beam in the graph, it can be seen that the first beam splitter 33 transmits almost 100% of an incident P polarization light beam with respect to a wavelength band ranging from about 500 nm to about 900 nm.

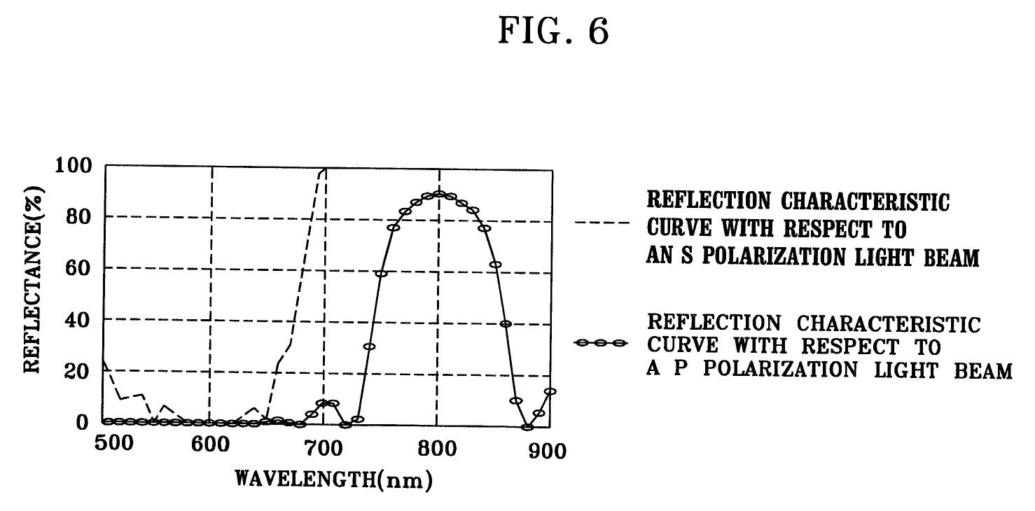

FIG. 6 is a graphical view showing optical characteristics of the second beam splitter 32 used in the optical recording/pickup head shown in FIGS. 3 and 4. In the graphical view of FIG. 6, the horizontal axis represents a wavelength of the light and the vertical axis represents a percentage ratio of a reflected light quantity with respect to an incident light quantity. According to a reflection characteristic curve with respect to an S polarization light beam in the graph, it can be seen that the second beam splitter 32 transmits about 100% of an incident S polarization light beam with respect to a wavelength band in the vicinity of about 650 nm, and reflects almost 100% of an incident S polarization light beam with respect to a wavelength band ranging from about 700 nm to about 900 nm. According to a reflection characteristic curve with respect to a P polarization light beam in the graph, it can be seen that the second beam splitter 32 transmits almost 100% of an incident P polarization light beam with respect to a wavelength band less than or equal to about 680 nm and reflects about 90% of an incident P polarization light beam with respect to a wavelength band ranging from about 770 nm to about 830 nm.

As described above, an optical recording/pickup head compatible with a CD-R and a DVD according to the embodiments of the present invention uses two beam splitters 32 and 33, which guide a first light beam and a second light beam emitted from respectively different light sources 1 and 40A toward an objective lens 7, and guide the first and second light beams reflected by optical disks 8 and 9 toward respectively different photodetectors 39 and 40B. The beam splitters 32 and 33 have polarized beam splitting characteristics which are varied according to a wavelength, in which the light quantities of the first and second light beams which are transmitted toward the objective lens 7 by the beam splitters 32 and 33 are substantially the same as those of the first and second light beams which are incident from the first light source 1 and the light source and photodetector 40. The former is preferably more than or equal to about 98% of the latter.

Thus, the optical recording/pickup head according to the present invention does not need to use additional devices such as an interference filter prism 4 and a converging lens 14, which causes a production cost to be lowered. Since the present invention uses two beam splitters 32 and 33 having a high transmissivity and reflectivity in order to alter an optical path of the first and second light beams, a high light utilization efficiency is provided.

While only certain embodiments of the invention have been specifically described herein, it will be apparent that numerous modifications may be made thereto without departing from the spirit and scope of the invention.

What is claimed is:

1. An optical recording/pickup head used with an optical disk driver and compatible with at least two types of optical disks in which distances from the optical recording/pickup head to the information recording surfaces differ from each other and information is recorded and reproduced by light beams having respectively different wavelengths, the optical recording/pickup head comprising:
a first light source to emit a linearly polarized first light beam if a first one of the at least two types of optical disks is loaded in the optical disk driver;
a second light source to emit a linearly polarized second light beam having a longer wavelength than that of the first light beam if a second one of the at least two types of optical disks is loaded in the optical disk driver;
a first photodetector;
a second photodetector;
focusing means for focusing the first and second light beams on the information recording surfaces of the first and second types of optical disks, respectively, and transmitting the first and second light beams reflected from the respective first and second types of optical disks; and
optical path alteration means to transmit the first light beam incident from the first light source and the second light beam incident from the second light source to the focusing means and transmitting the first and second light beams incident from the focusing means to the first and second photodetectors, respectively,
wherein the optical path alteration means transmits the first and second light beams so that light quantities of the first and second light beams incident to the optical path alteration means are substantially the same as light quantities of the first and second light beams having passed through the optical path alteration means.

2. The optical recording/pickup head according to claim 1, wherein said focusing means comprises:
an objective lens; and
a holographic variable aperture, between the optical path alteration means and the objective lens, to totally transmit the first light beam and to transmit only a portion of the second light beam, with respect to the first and second light beams transmitted from the optical path alteration means and proceeding toward the objective lens.

3. The optical recording/pickup head according to claim 2, further comprising a collimating lens, between the optical path alteration means and the holographic variable aperture, to collimate the first and second light beams incident from the optical path alteration means into respective parallel light beams and transmitting the parallel light beams to the holographic variable aperture.

4. The optical recording/pickup head according to claim 1, further comprising a phase plate located in an optical path between the optical path alteration means and the focusing means to convert the linearly polarized first and second light beams incident from the optical path alteration means into circularly polarized first and second light beams, and to convert the circularly polarized first and second light beams reflected from the respective first and second types of optical disks and incident from the focusing means into the linearly polarized first and second light beams; and
wherein the optical path alteration means comprises:
a first beam splitter to reflect the first light beam incident from said first light source toward the phase plate, to transmit the first light beam reflected from the first type optical disk and incident from the phase plate toward the first photodetector and to transmit the second light beam incident from the second light source and the second light beam reflected from the second type optical disk and incident from the first beam splitter; and
a second beam splitter to reflect the second light beam incident from the second light source toward the first beam splitter, to transmit the first light beam reflected from the first type optical disk and incident from the first beam splitter toward the first photodetector, and to reflect the second light beam reflected from the second type optical disk and incident from the first beam splitter toward the second photodetector.

5. The optical recording/pickup head according to claim 4, wherein the first and second beam splitters have polarization beam splitting characteristics which are varied according to a wavelength of the first and second light beams.

6. The optical recording/pickup head according to claim 5, wherein the first beam splitter transmits and reflects the linearly polarized first light beam incident from the first light source and the linearly polarized light incident from the phase plate according to the direction of polarization, and transmits the linearly polarized second light beams incident from the second light source and incident from the phase plate, and the second beam splitter transmits the linearly polarized first light beam incident from the first beam splitter, and reflects the linearly polarized second light beam incident from the second light source and the linearly polarized second light beam incident from the first beam splitter.

7. The optical recording/pickup head according to claim 4, further comprising a holographic beam splitter to transfer the second light beam emitted from said second light source to the second beam splitter and to transfer the second light beam incident from the second beam splitter to the second photodetector;
wherein the second light source and the second photodetector are integrally incorporated into a single unit.

8. The optical recording/pickup head according to claim 1, further comprising a phase plate located in an optical path between the optical path alteration means and the focusing means, to convert the linearly polarized first and second light beams incident from the optical path alteration means into circularly polarized first and second light beams, and to convert the circularly polarized first and second light beams incident from the focusing means into the linearly polarized first and second light beams; and
wherein said optical path alteration means comprises:
a first beam splitter to reflect the first light beam incident from the first light source toward the phase plate, and to transmit the first light beam reflected from the first type optical disk and incident from the phase plate toward the first photodetector;
a second beam splitter to transmit the first light beam incident from the first beam splitter and the first light beam reflected from the first type optical disk and incident from the phase plate, to reflect the second light beam incident from the second light source toward the phase plate, and to reflect the second light beam reflected from the second type optical disk and incident from the phase plate toward the second photodetector.

9. The optical recording/pickup head according to claim 8, wherein the first and second beam splitters have polarization beam splitting characteristics which are varied according to the wavelengths of the first and second light beams.

10. The optical recording/pickup head according to claim 9, wherein the first beam splitter transmits and reflects the linearly polarized first light beam incident from the first light source and the linearly polarized first light beam incident from the phase plate according to the direction of polarization, and the second beam splitter transmits the linearly polarized first light beam incident from the first beam splitter and the linearly polarized first light beam reflected from the first type optical disk and incident from the phase plate, and reflects the linearly polarized second light beam incident from the second light source and the linearly polarized second light beam incident from the phase plate.

11. The optical recording/pickup head according to claim 8, further comprising a holographic beam splitter to transfer the second light beam emitted from the second light source to the second beam splitter and to transfer the second light beam incident from the second beam splitter to the second photodetector;
wherein said second light source and said second photodetector is integrally incorporated into a single unit.

12. The optical recording/pickup head according to claim 1, wherein the first and second types of optical disks are a CD-R and a DVD, respectively.

13. An optical head assembly used with an optical disk driver and compatible with distinct first and second types of optical disks, comprising:
a first light source to emit a linearly polarized first light beam of a first wavelength, if the first type optical disk is loaded in the optical disk driver;
a second light source to emit a linearly polarized second light beam of a second wavelength longer than the first wavelength, if the second type optical disk is loaded in the optical disk driver;
a first photodetector;
a second photodetector; and
an optical path changing unit to direct the first light beam incident from said first light source and the second light beam incident from said second light source toward the respective first and second types of optical disks, and to direct the first and second light beams reflected from the respective first and second types of optical disks toward said first and second photodetectors, respectively;
wherein intensities of the first and second light beams received by said optical light path changing unit is substantially the same as intensities of the first and second light beams emitted by said optical path changing unit.

14. The optical head assembly as claimed in claim 13, further comprising a focusing unit, between said optical path changing unit and the optical disk driver, to focus the first and second light beams incident from said optical path changing unit on the first and second types of optical disks.

15. The optical head assembly as claimed in claim 14, further comprising a phase plate to convert the linearly polarized first light beam of a first polarization emitted from said first light source into a circularly polarized first light beam, to convert the circularly polarized first light beam reflected from the first type optical disk into a linearly polarized first light beam of a second polarization, to convert the linearly polarized second light beam of the first polarization emitted from said second light source into a circularly polarized second light beam, and to convert the circularly polarized second light beam reflected from the second type optical disk into a linearly polarized second light beam of the second polarization;
wherein said optical path changing unit transmits or reflects the first and second light beams based upon the polarization and wavelength of the first and second light beams incident upon said optical path changing unit.

16. The optical head assembly as claimed in claim 15, wherein
said optical path changing unit comprises
a first beam splitter, and
a second beam splitter; and
the first polarization is an S polarization and the second polarization is a P polarization;
said first photodetector, second beam splitter, first beam splitter, phase plate and focusing unit are linearly arranged in order;
said first beam splitter reflects substantially all of the first light beam having the S polarization and transmits substantially all of the first light beam having the P polarization, and the second light beam having the S and the P polarizations; and
said second beam splitter reflects substantially all of the second light beam having the S and the P polarizations, and transmits substantially all of the first light beam having the P polarization.

17. The optical head assembly as claimed in claim 16, wherein said focusing unit comprises:
a variable aperture including
a first region to pass all of the first and second light beams incident from said first beam splitter, and
a second region, surrounding said first region, to pass only the first light beam incident from said first beam splitter; and
an objective lens to focus the first and second light beams passing through said variable aperture on the respective first and second types of optical disks.

18. The optical head assembly as claimed in claim 17, wherein the first wavelength is approximately 650 nm, the second wavelength is approximately 780 nm, the first type of optical disk is a digital versatile disk (DVD), the second type of optical disk is a recordable compact disk (CD-R), the first region has a numerical aperture no greater than approximately 0.45 and the second region has a numerical aperture greater than 0.45.

19. The optical head assembly as claimed in claim 15, wherein
said optical path changing unit comprises
a first beam splitter, and
a second beam splitter; and
the first polarization is an S polarization and the second polarization is a P polarization;
said first photodetector, first beam splitter, second beam splitter, phase plate and focusing unit are linearly arranged in order;
said first beam splitter reflects substantially all of the first light beam having the S polarization and transmits substantially all of the first light beam having the P polarization; and
said second beam splitter reflects substantially all of the second light beam having the S and the P polarizations, and transmits substantially all of the first light beam having the S and the P polarizations.

20. The optical head assembly as claimed in claim 19, wherein said focusing unit comprises:
a variable aperture including
a first region to pass all of the first and second light beams incident from said first beam splitter, and
a second region, surrounding said first region, to pass only the first light beam incident from said first beam splitter; and
an objective lens to focus the first and second light beams passing through said variable aperture on the respective first and second types of optical disks.

21. The optical head assembly as claimed in claim 20, wherein the first wavelength is approximately 650 nm, the second wavelength is approximately 780 nm, the first type of optical disk is a digital versatile disk (DVD), the second type of optical disk is a recordable compact disk (CD-R), the first region has a numerical aperture no greater than approximately 0.45 and the second region has a numerical aperture greater than 0.45.

22. An optical head assembly used with an optical disk driver and compatible with distinct first and second types of optical disks, comprising:
a first light source to emit a linearly polarized first light beam of a first polarity and a first wavelength, if the first type optical disk is loaded in the optical disk driver;
a second light source to emit a linearly polarized second light beam of the first polarity and a second wavelength longer than the first wavelength, if the second type optical disk is loaded in the optical disk driver;
a first photodetector;
a second photodetector; and
an optical path changing unit to direct the first light beam incident from said first light source and the second light beam incident from said second light source toward the respective first and second types of optical disks, and to direct the first and second light beams reflected from the respective first and second types of optical disks toward said first and second photodetectors, respectively;
a phase plate to convert the linearly polarized first light beam of the first polarization emitted from said first light source into a circularly polarized first light beam, to convert the circularly polarized first light beam reflected from the first type optical disk into a linearly polarized first light beam of the second polarization, to convert the linearly polarized second light beam of the first polarization emitted from said second light source into a circularly polarized second light beam, and to convert the circularly polarized second light beam reflected from the second type optical disk into a linearly polarized second light beam of the second polarization;
wherein said optical path changing unit transmits or reflects the first and second light beams, based upon the wavelength and the polarization of the first and second light beams received by said optical path changing unit.

23. The optical head assembly as claimed in claim 22, wherein
said optical path changing unit comprises
a first beam splitter, and
a second beam splitter; and
the first polarization is an S polarization and the second polarization is a P polarization;
said first photodetector, second beam splitter, first beam splitter, phase plate and focusing unit are linearly arranged in order;
said first beam splitter reflects substantially all of the first light beam having the S polarization and transmits substantially all of the first light beam having the P polarization, and the second light beam having the S and the P polarizations; and
said second beam splitter reflects substantially all of the second light beam having the S and the P polarizations, and transmits substantially all of the first light beam having the P polarization.

24. The optical head assembly as claimed in claim 22, wherein
said optical path changing unit comprises
a first beam splitter, and
a second beam splitter; and
the first polarization is an S polarization and the second polarization is a P polarization;
said first photodetector, first beam splitter, second beam splitter, phase plate and focusing unit are linearly arranged in order;
said first beam splitter reflects substantially all of the first light beam having the S polarization and transmits substantially all of the first light beam having the P polarization; and
said second beam splitter reflects substantially all of the second light beam having the S and the P polarizations, and transmits substantially all of the first light beam having the S and the P polarizations.
